(19) United States
(12) Patent Application Publication
(10) Pub. No.: US 2011/0285360 A1
(43) Pub. Date: Nov. 24, 2011

(54) Energy-Saving Charger

(76) Inventor: Hui-Nan LIN, Kaohsiung City (TW)

(21) Appl. No.: 12/786,000

(22) Filed: May 24, 2010

(51) Int. Cl. H02J 7/04

(52) U.S. Cl. 320/162

(57) ABSTRACT

An energy-saving charger comprises: an AC power input terminal, a power-off switch, a power convertor, a DC output charging terminal, a detection and control device, and a charging-control switch. The detection and control device can detect the charging state, and when the electric appliance or battery is done charging, the detection and control device will cut off the power supply to stop the charging of the battery by turning off the power-off switch, thus providing an energy-saving charging mode.

### BACKGROUND OF THE INVENTION

1. Field of the Invention

The present invention relates to a charger, and more particularly to an energy-saving charger.

2. Description of the Prior Art

Electric appliances are powered by electric power, and the electric power includes DC (direct current) power and AC (alternative current) power. Many portable electric appliances, such as mobile phones, are normally powered by rechargeable batteries which are DC devices, and the DC batteries must be electrically connected to and charged by AC power source.

A conventional recharge mode is shown in FIGS. 1 and 2, wherein a rechargeable electric appliance 11 is connected to a charging circuit 12 which is a normal transformer connected to an input power source 13. When the rechargeable electric appliance 11, the charging circuit 12 and the input power source 13 are connected together, the rechargeable electric appliance 11 can be charged. The charging circuit 12 is connected to a switch 14 for controlling the power source. When the rechargeable electric appliance 11 is done charging, the user can turn off the switch 14 to stop the power source from charging the rechargeable electric appliance 11. Although the switch 14 can stop the power supply, in real situation, the user can't keep watching over the switch 14 all the time, sometimes the switch 14 is still not turned off when the rechargeable electric appliance 11 is fully charged. Therefore, the input power source 13 is maintained in electric contact with the rechargeable electric appliance 11, namely, the current doesn't stops flowing, constantly causing power consumption, which is not only uneconomic but also not environmentally friendly.

The present invention has arisen to mitigate and/or obviate the afore-described disadvantages.

### SUMMARY OF THE INVENTION

The primary object of the present invention is to provide an energy-saving charger which is capable of determining the charging state and cutting off the power supply when charging is finished.

To achieve the above object, an energy-saving charger provided in accordance with the present invention comprises: an AC power input terminal, a power-off switch, a power convertor, a DC output charging terminal, a detection and control device, and a charging-control switch.

The AC power input terminal is electrically connected to AC power.

The power-off switch is electrically connected to the AC power input terminal.

The power convertor for converting AC current into DC current is electrically connected to the power-off switch in such a manner that the power-off switch is electrically connected between the AC power input terminal and the power convertor;

The DC output charging terminal is electrically connected to the power convertor and electric appliances or batteries to be charged, so that DC current is outputted from the power convertor to the DC output charging terminal;

The detection and control device is electrically connected to the power-off switch, the power convertor and the DC output charging terminal and comprises a detection unit, a comparing and determining unit, and a control unit which are connected one another, the detection unit detects a charging current flowing from the DC output charging terminal to the batteries, the comparing and determining unit determines charging state of the batteries, the control unit serves to control ON and OFF of the power-off switch according to the determining result of the comparing and determining unit.

The charging-control switch is electrically connected to the detection and control unit and controls the connection and disconnection of the AC power input terminal to the power convertor by turning on and off the power-off switch.

### BRIEF DESCRIPTION OF THE DRAWINGS

FIG. 1 is a diagram of a conventional charger;

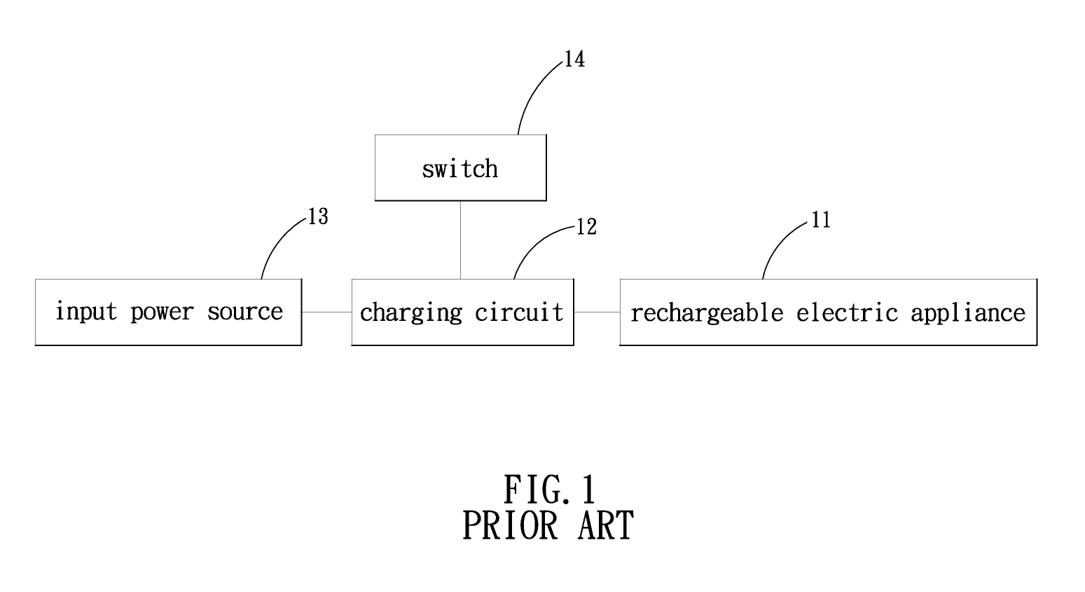

FIG. 2 is a perspective view of the conventional charger;

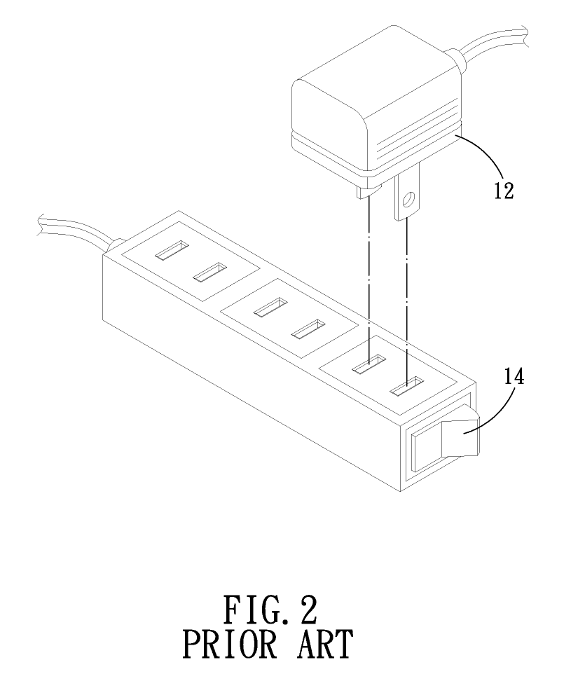

FIG. 3 is a diagram of an energy-saving charger in accordance with the present invention; and

FIG. 4 is a flow chart showing the operation of the energy-saving charger in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

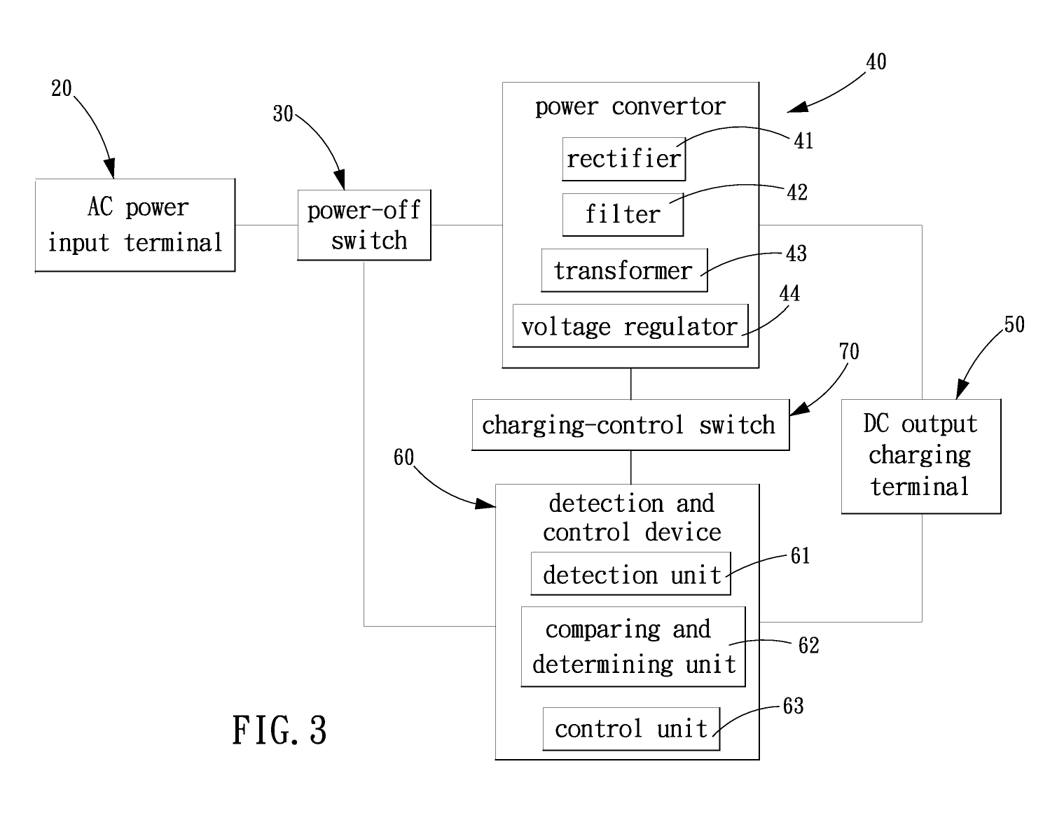

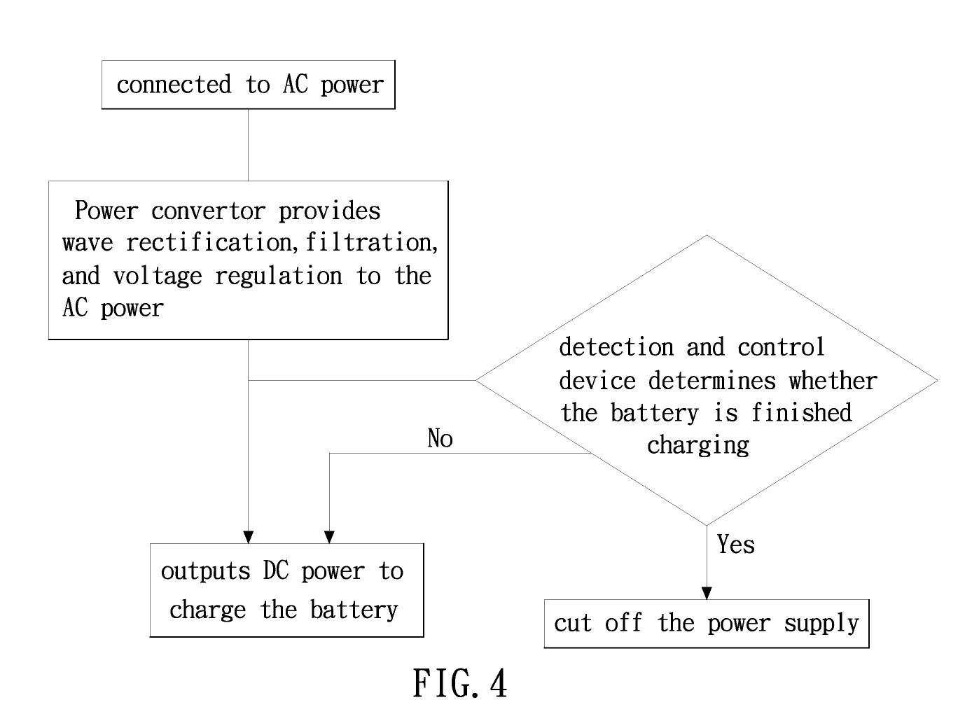

Referring to FIGS. 3 and 4, an energy-saving charger in accordance with a preferred embodiment of the present invention comprises: an AC power input terminal 20, a power-off switch 30, a power convertor 40, a DC output charging terminal 50, a detection and control device 60, and a charging-control switch 70.

The AC power input terminal 20, in this embodiment, is a plug which can be electrically connected to AC power.

The power-off switch 30 is silicon controlled in this embodiment and electrically connected to the AC power input terminal 20.

The power convertor 40 is electrically connected to the power-off switch 30 in such a manner that the power-off switch 30 is electrically connected between the AC power input terminal 20 and the power convertor 40. The power convertor 40 includes a rectifier 41, a filter 42, a transformer 43 and a voltage regulator 44 which are connected one another. After the AC power imputer terminal 20 is electrically connected to the power convertor 40, the rectifier 41 is a bridge rectifier for performing full wave-form rectification of the AC current, the filter 42 which is a π filter then provides filtration action, after filtration, the transformer 43 provides voltage transformation, and finally, the voltage regulator 44 provides voltage regulation and outputs DC current.

The power convertor 40 is electrically connected to the DC output charging terminal 50, so that the DC current is outputted from the power convertor 40 to the DC output charging terminal 50, and the DC output charging terminal 50 can be electrically connected to electric appliances or batteries to perform charging operation.

The detection and control device 60 is electrically connected to the power-off switch 30, the power convertor 40 and the DC output charging terminal 50 and comprises a detection unit 61, a comparing and determining unit 62, and a control unit 63 which are connected one another. The detection unit 61 detects the amount of the charging current flowing from the DC output charging terminal 50 to the batteries. The comparing and determining unit 62 determines whether it is in a charging state or in a non-current-output state (charging is finished) based on the detected amount of the current. When the comparing and determining unit 62 determines that the power convertor 40 keeps outputting current, the control unit 63 will turn on the power-off switch 30, making the AC power input terminal 20 electrically connected to the power convertor 40. When the comparing and determining unit 62 determines that the amount of current outputted from the power convertor 40 is becoming less and less or even drops down to zero, the control unit 63 will turn off the power-off switch 30 to disconnect the AC power input terminal 20 from the power convertor 40.

The charging-control switch 70 is electrically connected to the detection and control unit 60 and controls the connection and disconnection of the AC power input terminal 20 to the power convertor 40 by turning on and off the power-off switch 30. The charging-control switch 70 can be provided with 3V built-in batteries to manually turn on the power-off switch 30.

The abovementioned is the structure relations of the respective components of the energy-saving charger in accordance with the present invention, for a better understanding of its operation, reference should be made to FIG. 4. The AC power input terminal 20 is electrically connected to AC power, and the DC output charging terminal 50 is electrically connected to electric appliances or batteries to be charged. Pressing the charging-control switch 70 can bring the AC power input terminal 20 into electric contact with the power convertor 40, so that AC power is transmitted to the power convertor 40, and the rectifier 41, the filter 42, the transformer 43 and the voltage regulator 44 provide rectification, filtration, transformation and regulation operation, making the power convertor 40 output stable DC power. The detection and control device 60 detects the amount of current flowing into the batteries. If current is flowing into the batteries, the comparing and determining unit 62 will determine that it is in a charging state, and the control unit 63 will keep turning on the power-off switch 30, so that the AC power input terminal 20 is maintained in electrical connection with the power convertor 40. When the detection unit 61 detects that the amount of current outputted from the power convertor 40 drops down to zero, the control unit 63 will turn off the power-off switch 30 to disconnect the AC power input terminal 20 from the power convertor 40, making the AC power input terminal 20 stop inputting current.

When an electric appliance or a battery is being charged, the detection and control device 60 can detect the charging current, and when the electric appliance or battery is done charging, the detection and control device 60 will cut off the power supply to stop the charging of the battery by turning off the power-off switch 30, providing an energy-saving charging mode.

While we have shown and described various embodiments in accordance with the present invention, it is clear to those skilled in the art that further embodiments may be made without departing from the scope of the present invention.

What is claimed is:

1. An energy-saving charger comprising:
an AC power input terminal electrically connected to AC power;
a power-off switch electrically connected to the AC power input terminal;
a power convertor for converting AC current into DC current being electrically connected to the power-off switch in such a manner that the power-off switch is electrically connected between the AC power input terminal and the power convertor;
a DC output charging terminal electrically connected to the power convertor and electric appliances or batteries to be charged, so that DC current is outputted from the power convertor to the DC output charging terminal;
a detection and control device being electrically connected to the power-off switch, the power convertor and the DC output charging terminal and comprising a detection unit, a comparing and determining unit, and a control unit which are connected one another, the detection unit serving to detect a charging current flowing from the DC output charging terminal to the batteries, the comparing and determining unit determining charging state of the batteries, the control unit serving to control ON and OFF of the power-off switch according to determining result of the comparing and determining unit; and
a charging-control switch being electrically connected to the detection and control unit and controlling connection and disconnection of the AC power input terminal to the power convertor by turning on and off the power-off switch.

2. The energy-saving charger as claimed in claim 1, wherein the power convertor includes a rectifier, a filter, a transformer and a voltage regulator which are connected one another, the rectifier performs rectification of the AC current, the filter provides filtration action, the transformer provides voltage transformation, and the voltage regulator provides voltage regulation.

3. The energy-saving charger as claimed in claim 2, wherein the rectifier is a bridge rectifier for performing full wave-form rectification.

4. The energy-saving charger as claimed in claim 2, wherein the filter is a π filter.
